(19) United States
(12) Patent Application Publication
(10) Pub. No.: US 2022/0413105 A1
(43) Pub. Date: Dec. 29, 2022

(54) LIDAR AND LIDAR SCANNING METHOD

(71) Applicant: SUTENG INNOVATION TECHNOLOGY CO., LTD., Shenzhen (CN)

(72) Inventor: Ji WANG, Shenzhen (CN)

(73) Assignee: SUTENG INNOVATION TECHNOLOGY CO., LTD., Shenzhen (CN)

(21) Appl. No.: 17/895,051

(22) Filed: Aug. 24, 2022

Related U.S. Application Data
(63) Continuation of application No. PCT/CN2020/077321, filed on Feb. 29, 2020.

(51) Int. Cl. G01S 7/481; G01S 17/89

(52) U.S. Cl. CPC G01S 7/4817; G01S 17/89

(57) ABSTRACT

A LiDAR and a LiDAR scanning method are provided. The LiDAR includes a transceiving module, a control unit, a galvanometer, and a motor. The galvanometer is a one-dimensional galvanometer. The galvanometer is driven by the control signal to perform vertical scanning, and the galvanometer performs horizontal scanning as the motor rotates, so that the LiDAR performs scanning in the horizontal direction and the vertical direction. Through the present application, a scanning range of the LiDAR can be enlarged, a structure of the LiDAR can be simplified, and resolution and precision of the LiDAR can be improved.

### CROSS-REFERENCE TO RELATED APPLICATION

The present application is a continuation of International Application No. PCT/CN2020/077321, filed on Feb. 29, 2020, the content of which is incorporated herein by reference in its entirety.

### TECHNICAL FIELD

The present application relates to the field of detection, and in particular, to a LiDAR and a LiDAR scanning method.

### BACKGROUND

A LiDAR is a radar system that emits a laser beam to obtain characteristics of a target such as position and speed. The working principle of the LiDAR is to first emit detection laser beams to the target, then compare the received signals reflected from the target with the emitted signals, and properly process the signals to obtain relevant information of the target, for example, parameters of the target such as distance, azimuth, height, speed, posture, and even shape.

The inventor finds that, to improve detection resolution of an existing multi-line LiDAR, usually a great number of lasers and detectors need to be stacked. A system embodiment and a circuit structure of the LiDAR are relatively complex and highly costly and thus can be further simplified.

### SUMMARY

Embodiments of the present application provide a LiDAR, so that the scanning range of the LiDAR can be enlarged, a system and a structure of the LiDAR can be simplified, and resolution and precision of the LiDAR can be improved.

In order to solve the above technical problems, the embodiments of the present application disclose the following technical solutions:

In a first aspect, this application provides a LiDAR, which includes: a transceiving module, a galvanometer, a motor, and a control unit,
where the transceiving module is configured to emit an outgoing laser and receive an echo laser;
where the galvanometer is configured to receive the outgoing laser emitted by the transceiving module, and to deflect the outgoing laser outward to scan in a first direction, and is further configured to receive the echo laser, and deflect the received echo laser toward the transceiving module;
where the motor is configured to drive the galvanometer to rotate, so that the outgoing laser can scan in a second direction after being deflected by the galvanometer; and
the control unit is configured to send a control signal to control the transceiving module, the galvanometer, and the motor.

In a possible embodiment, the control unit is specifically configured to send a first control signal to the transceiving module, to send a second control signal to the galvanometer, and to send a third control signal to the motor,
where the first control signal is used to control the transceiving module to emit the outgoing laser and receive the echo laser;
where the second control signal is used to control the galvanometer to scan in the first direction; and
where the third control signal is used to control the motor to drive the galvanometer to rotate in the second direction.

In a possible embodiment, the control unit includes: a transceiving control unit, a galvanometer control unit, and a motor control unit;
where the transceiving control unit is configured to control an emission frequency and/or laser intensity of the outgoing laser emitted by the transceiving module;
where the galvanometer control unit is configured to control a scanning angle and a scanning frequency of the galvanometer in the first direction; and
where the motor control unit is configured to control an angular velocity and angular acceleration of the motor in the second direction.

In a possible embodiment, the motor control unit further includes an encoder configured to obtain a rotation angle of the motor in the second direction.

In a possible embodiment, the first control signal is a square wave signal, where a frequency of the square wave signal is related to an emission frequency of the outgoing laser, and magnitude of a level of the square wave signal is related to laser intensity of the outgoing laser.

In a possible embodiment, a vertical scanning mode indicated by the second control signal includes sine wave scanning or triangular wave scanning, and where the angular acceleration indicated by the third control signal is zero.

In a possible embodiment, the LiDAR further includes: a signal processing unit,
where the signal processing unit is configured to generate a point cloud image based on the echo laser.

In a possible embodiment, the signal processing unit determines a point cloud position based on the scanning angle of the galvanometer in the first direction and the rotation angle of the motor in the second direction, and generates a point cloud image based on the point cloud position.

In a possible embodiment, the control unit is further configured to send a fourth control signal to the transceiving module, where the fourth control signal is used to control the transceiving module to receive the echo laser.

In a possible embodiment, the transceiving module includes: an emitter, an emitting optical unit, a beam splitting unit, a receiver, and a receiving optical unit, where
the emitter is configured to emit the outgoing laser based on the control signal;
the emitting optical unit is configured to collimate the outgoing laser from the emitter;
the beam splitting unit is configured to transmit the collimated outgoing laser, to receive the echo laser which is deflected by the galvanometer, and to deflect the echo laser to the receiving optical unit;
the receiving optical unit is configured to focus, on the receiver, the echo laser deflected by the beam splitting unit; and
the receiver is configured to receive the echo laser after being focused.

In a second aspect, a LiDAR scanning method is provided and applied to the foregoing LiDAR, where the LiDAR includes a transceiving module, a control unit, a galvanometer, and a motor; and the method includes:
emitting, by the transceiving module, an outgoing laser, and receiving an echo laser;
receiving, by the galvanometer, the outgoing laser emitted by the transceiving module, deflecting the outgoing laser outward to scan in a first direction, receiving the echo laser, and deflecting the received echo laser toward the transceiving module;
driving, by the motor, the galvanometer to rotate, so that the outgoing laser can scan in a second direction after being deflected by the galvanometer; and
controlling, by the control unit, the transceiving module, the galvanometer, and the motor.

In the embodiments, the LiDAR includes the transceiving module, the control unit, the galvanometer, and the motor. The galvanometer is arranged on the motor. The control unit sends the control signal to the galvanometer to control the galvanometer scan in the vertical direction, and sends the control signal to the motor to control the motor to rotate to drive the galvanometer to perform 360° scanning in the horizontal direction, so that the galvanometer performs scanning in the vertical direction and the horizontal direction. In the embodiments of the present application, the galvanometer only needs to scan in the vertical direction. That is, the galvanometer is a one-dimensional galvanometer. Compared with a two-dimensional galvanometer, the one-dimensional galvanometer has a larger scanning angle and a larger mirror size, thereby improving a scanning range and a detection distance of the LiDAR. The galvanometer can perform 360° horizontal scanning through rotation of the motor. Compared with a limited horizontal scanning angle of the two-dimensional galvanometer, a horizontal scanning angle of the galvanometer is larger Therefore, scanning angles of the LiDAR in the vertical direction and the horizontal direction can be increased, so that the system and structure of the LiDAR can be simplified, the scanning range of the LiDAR can be increased, and the resolution and detection distance of the LiDAR can be increased.

### BRIEF DESCRIPTION OF DRAWINGS

In order to explain embodiments of the present application or the technical solutions in the related art more clearly, the following briefly introduces the drawings that need to be used in the embodiments. Obviously, the drawings in the following description are only some of embodiments of the present application. The person skilled in the art can obtain other drawings based on these drawings without creative work.

FIG. 1 is a schematic structural diagram of a LiDAR according to an embodiment of the present application;

FIG. 2 is another schematic structural diagram of a LiDAR according to an embodiment of the present application;

FIG. 3 is a schematic diagram of vertical scanning performed by a galvanometer according to an embodiment of the present application;

FIG. 4 is another schematic diagram of vertical scanning performed by a galvanometer according to an embodiment of the present application;

FIG. 5 is a point cloud image obtained through scanning performed by a LiDAR according to an embodiment of the present application; and

FIG. 6 is another point cloud image obtained through scanning performed by a LiDAR according to an embodiment of the present application.

### DETAILED DESCRIPTION

Embodiments of the present application provide a LiDAR and a LiDAR scanning method, so that a scanning range of the LiDAR can be enlarged, and resolution and precision of the LiDAR can be improved.

The following describes the technical solutions in the embodiments of the present application in conjunction with the drawings in the embodiments of the present application. Obviously, the described embodiments are only a part of the embodiments of the present application, rather than all embodiments. Based on the embodiments of the present application, all other embodiments obtained by the person skilled in the art without creative labor shall fall within the protection scope of the present application.

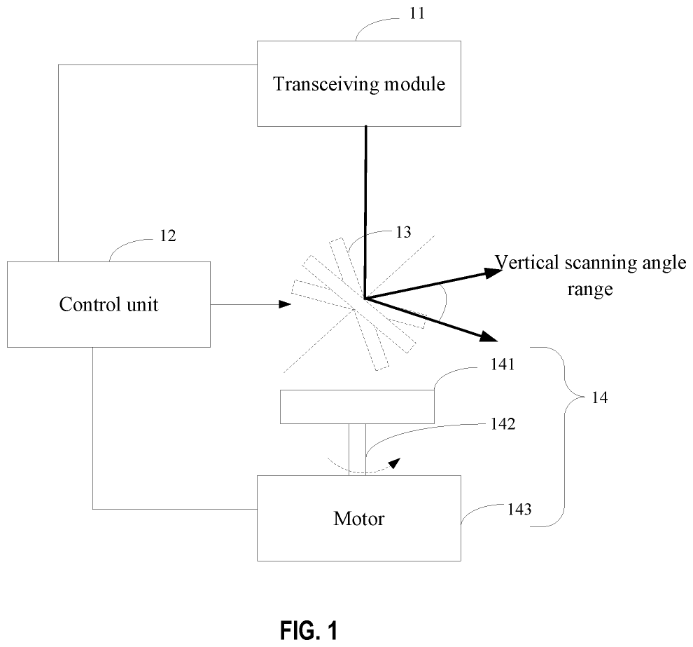

Referring to FIG. 1, FIG. 1 is a schematic structural diagram of a LiDAR according to an embodiment of the present application. As shown in FIG. 1, the LiDAR includes: a transceiving module 11, a control unit 12, a galvanometer 13, and a motor 14. Optionally, the motor 14 includes a platform 141, a rotor 142, and a stator 143. The galvanometer 13 is arranged on the platform 141. For example, the motor 14 has a housing and the stator 143 is arranged in the housing. The rotor 142 includes a rotating shaft, and the platform is fixed on the top of the rotating shaft. The platform 141 is perpendicular to the rotor. The rotating shaft is perpendicular to the stator 143. The galvanometer 13 is fixedly arranged on the platform. The galvanometer 13 is driven to rotate around the rotating shaft in the horizontal direction when the motor 14 rotates. A rotation direction of the motor 14 can be clockwise or counter-clockwise. The control unit 12 may be a central processing unit (CPU), a network processor (NP), or a combination of the CPU and the NP. The processor can further include a hardware chip. The foregoing hardware chip can be an application-specific integrated circuit (ASIC), a programmable logic device (PLD), or a combination of them. The foregoing PLD may be a complex programmable logic device (CPLD), a field-programmable gate array (FPGA), a generic array logic (GAL), or any combination thereof.

In this embodiment, a first direction and a second direction are perpendicular to each other. For example, the first direction is a vertical direction, and the second direction is a horizontal direction; or the first direction is the horizontal direction, and the second direction is the vertical direction.

The transceiving module 11 is configured to emit an outgoing laser and receive an echo laser.

The galvanometer 13 is configured to receive the outgoing laser emitted by the transceiving module 11, and to deflect the outgoing laser outward to perform scan in a first direction. The galvanometer 13 is further configured to receive the echo laser, and to deflect the received echo laser toward the transceiving module 11.

The motor 14 is configured to drive the galvanometer 13 to rotate, so that the outgoing laser can scan in a second direction after being deflected by the galvanometer 13.

The control unit 12 is configured to send a control signal to control the transceiving module 11, the galvanometer 13, and the motor 14.

In a possible embodiment, the control unit 12 is configured to send a first control signal to the transceiving module 11, and the first control signal is used to control the transceiving module 11 to emit an outgoing laser. The first control signal is an electrical signal, and the first control signal controls the transceiving module 11 to emit the outgoing laser. Optionally, when the first control signal is at a high level, the transceiving module 11 emits the outgoing laser, and when the first control signal is at a low level, the transceiving module 11 stops emitting the outgoing laser.

The transceiving module 11 is configured to emit an outgoing laser based on the first control signal. The transceiving module 11 is also configured to receive an echo laser reflected after the outgoing laser reaches a target object.

The control unit 12 is also configured to send a second control signal to the galvanometer 13. The second control signal is used to control the galvanometer to scan in the first direction, and the galvanometer is a one-dimensional galvanometer. For example, the second control signal is used to control the galvanometer to perform vertical scanning. The second control signal is an electrical signal. The second control signal may be a single-frequency signal, and a frequency of the second control signal is equal to a resonance frequency of the galvanometer. A scanning mode of the galvanometer in the vertical direction can be any of a sine wave mode, a cosine wave mode, or a triangular wave mode. The galvanometer 13 has a vertical scanning angle range in the vertical direction, and the vertical scanning angle range is determined by a hardware characteristic of the galvanometer.

The galvanometer 13 is configured to deflect the outgoing laser from the transceiving module 11 in the first direction, and to direct the outgoing laser in a deflected direction at the target object. In this embodiment of the present application, the galvanometer 13 can be a MEMS (Micro-Electro-Mechanical System) galvanometer, or other mechanical or electronic galvanometers.

The control unit 12 is further configured to send a third control signal to the motor 14, where the third control signal is used to control the motor 14 to drive the galvanometer 13 to rotate in the second direction. The third control signal is an electrical signal, and the third control signal can be a pulse width modulation signal. An angular velocity of the motor 14 is adjusted through a pulse width of the pulse width modulation signal. The larger the pulse width is, the larger the angular velocity of the motor 14 is. The smaller the pulse width is, the smaller the angular velocity of the motor 14 is.

The motor 14 is configured to rotate in the second direction based on the third control signal. For example, the motor 14 drives the galvanometer 13 on the platform 141 to perform horizontal scanning, so that the galvanometer 13 performs 360° scanning in the horizontal direction.

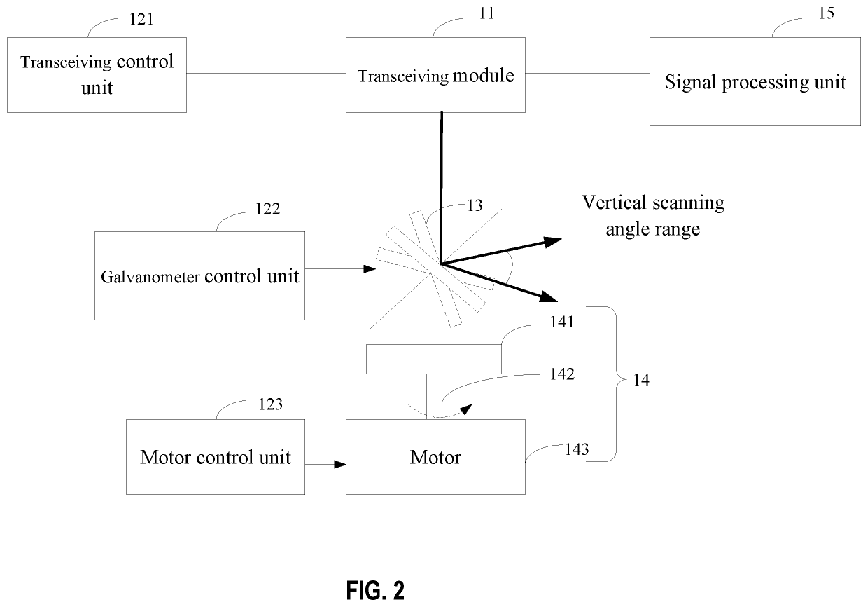

Further, referring to FIG. 2, the control unit 12 includes a transceiving control unit 121, a galvanometer control unit 122, and a motor control unit 123.

The transceiving control unit 121, the galvanometer control unit 122, and the motor control unit 123 may be circuit units implemented through hardware, or may be devices such as processors, FPGA, CPLD, or GAL. The transceiving control unit 121 sends a first control signal to the transceiving module 11. The first control signal indicates one or more of an emission frequency and laser intensity of the outgoing laser. The first control signal is used to control the transceiving module 11 to emit an outgoing laser according to one or more of the emission frequency and the laser intensity.

Optionally, the first control signal may be a square wave signal. A frequency of the square wave signal is related to the emission frequency of the outgoing laser. Magnitude of a level of the square wave signal is related to the laser intensity of the outgoing laser. The frequency of the square wave signal is positively correlated with the emission frequency of the outgoing laser. The magnitude of the level of the square wave signal is positively correlated with the laser intensity of the outgoing laser. A mapping relationship between the frequency of the square wave signal and the emission frequency of the outgoing laser, and a mapping relationship between the magnitude of the level of the square wave signal and the laser intensity of the outgoing laser can be pre-stored or pre-configured in the transceiving module 11. The transceiving module 11 determines the emission frequency and the laser intensity of the outgoing laser based on the frequency and the magnitude of the level of the first control signal when receiving the first control signal from the transceiving control unit 121.

Optionally, the first control signal may be a signaling message. The signaling message carries the emission frequency and the laser intensity of the outgoing laser. When receiving the first control signal, the transceiving module 11 parses out the emission frequency and the laser intensity carried in the first control signal, and emits the outgoing laser based on the parsed emission frequency and laser intensity.

The galvanometer control unit 122 is configured to send a second control signal to the galvanometer 13, and the second control signal is used to control a scanning angle and a scanning frequency of the galvanometer in the first direction. For example, the second control signal indicates one or more of a vertical scanning mode, a vertical scanning angle, and a vertical scanning frequency, and the second control signal is used to control the galvanometer to perform vertical scanning based on one or more of the vertical scanning mode, the vertical scanning angle, and the vertical scanning frequency.

The second control signal may be the single-frequency signal, and the galvanometer control unit 122 controls, through parameters such as a frequency, amplitude, and a phase of the single-frequency signal, the galvanometer 13 to scan in the vertical direction. The vertical scanning mode indicates the scanning mode of the galvanometer in the vertical direction. The vertical scanning mode includes: sine wave scanning, cosine wave scanning, or triangular wave scanning. The sine wave scanning means that the galvanometer performs scanning in the vertical direction in the form of a sine wave. The triangular wave scanning means that the galvanometer performs scanning in the vertical direction in the form of a triangular wave. The cosine wave scanning means that the galvanometer performs scanning in the vertical direction in the form of a cosine wave. The vertical scanning angle indicates the maximum amplitude of scanning performed by the galvanometer in the vertical direction. The vertical scanning frequency indicates the frequency of scanning performed by the galvanometer in the vertical direction, that is, the number of cycles of scanning in the vertical direction per unit time.

The motor control unit 123 is configured to send a third control signal to the motor 14, and the third control signal indicates one or more of an angular velocity, angular acceleration, and a horizontal scanning frequency of the motor in the second direction. For example, the motor 14 rotates based on one or more of the angular velocity, the angular acceleration, and the horizontal scanning frequency.

The third control signal may be an electrical signal. For example, the third control signal is a pulse width modulation signal. Parameters of the motor 14 such as the angular velocity, the angular acceleration, and the horizontal scanning frequency are controlled based on a pulse width of the pulse width modulation signal. The angular velocity indicates a rotation angle of the motor per unit time. The angular acceleration indicates an increase in the angular velocity per unit time. The horizontal scanning frequency indicates the number of cycles of the motor per unit time, and one cycle corresponds to 360°.

In a possible embodiment, the scanning mode indicated by the second control signal in the first direction includes the sine wave scanning or the triangular wave scanning.

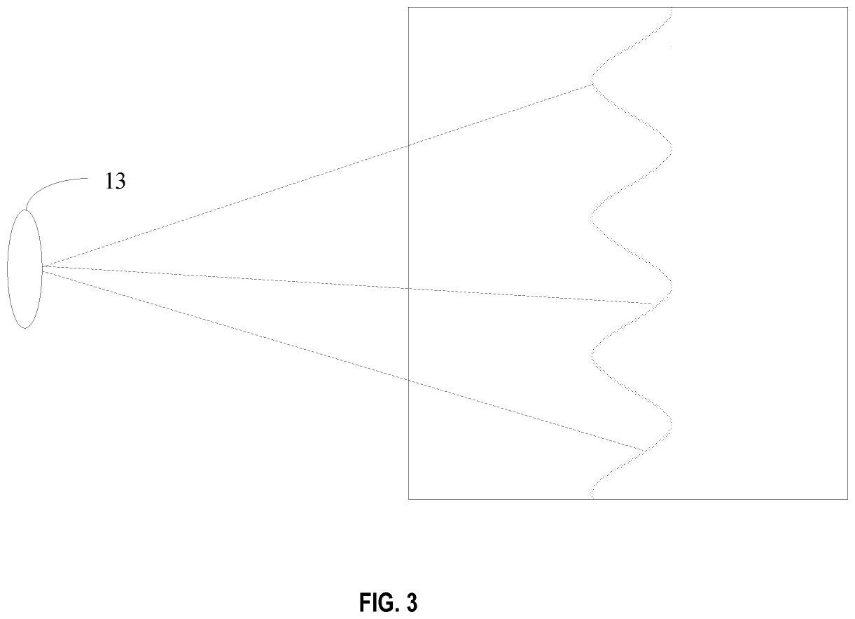

For example, referring to FIG. 3, FIG. 3 is a waveform diagram of scanning performed by the galvanometer 13 in a vertical direction. The galvanometer 13 performs sine wave scanning in the vertical direction based on the second control signal, and the scanning waveform of the galvanometer 13 in the vertical direction is the sine wave.

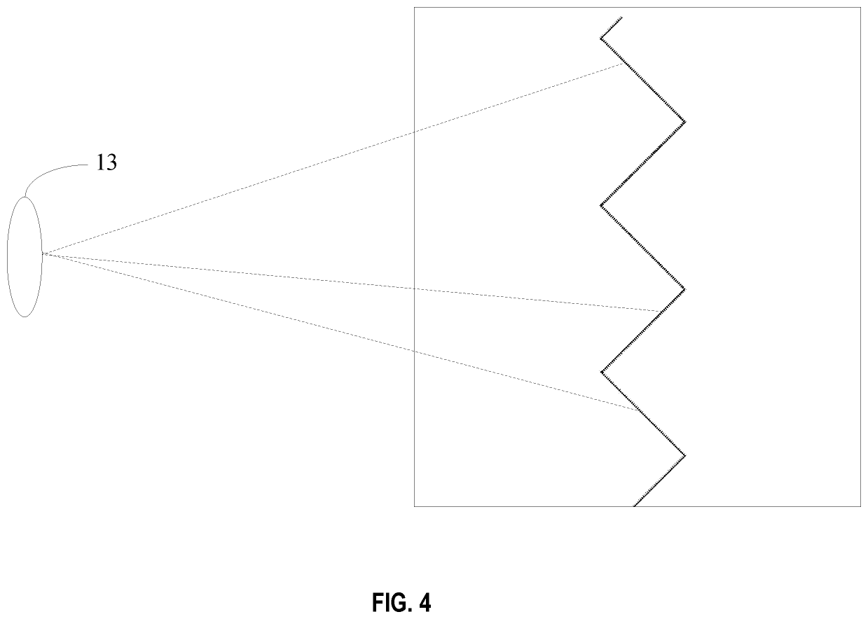

For another example, referring to FIG. 4, FIG. 4 is a waveform diagram of scanning performed by the galvanometer 13 in a vertical direction. The galvanometer 13 performs triangular wave scanning in the vertical direction based on the second control signal, and the scanning waveform of the galvanometer 13 in the vertical direction is the triangular wave.

In a possible embodiment, the angular acceleration indicated by the third control signal is zero, namely, the motor 14 rotates at a constant angular velocity. The motor control unit can also detect the angular velocity, the angular acceleration, the horizontal scanning frequency, and the like during rotation of the motor, and controls a rotation parameter of the motor through closed-loop feedback to satisfy a preset value. The rotation parameter includes one or more of the angular velocity, the angular acceleration, and the horizontal scanning frequency.

In a possible embodiment, the LiDAR further includes a signal processing unit. The galvanometer 13 is also configured to receive the echo laser formed after the outgoing laser reaches the target object, to deflect the echo laser from a direction and then send the echo laser to the transceiving module. The control unit 12 is further configured to send a fourth control signal to the transceiving module, where the fourth control signal is used to control the transceiving module to receive the echo laser. The transceiving module 11 is also configured to receive the echo laser based on the fourth control signal. The signal processing unit 15 is configured to generate a point cloud image based on the echo laser.

The signal processing unit 15 may be a device such as a processor, FPGA, CPLD, or GAL. A point cloud image includes a plurality of point clouds. The point cloud is generated by the echo laser formed when the outgoing laser reaches the target object. A position of the point cloud is determined by the vertical scanning angle of the galvanometer and a horizontal rotation angle of the motor. In this embodiment of the present application, an emission frequency of the outgoing laser, a vertical scanning frequency of the galvanometer 13, and an angular velocity of the motor 14 can be controlled, to control angular resolution of the LiDAR. In the vertical direction, the higher the emission frequency of the outgoing laser emitted by the transceiving module 11 is, the larger the vertical angular resolution of the LiDAR is. On the contrary, the lower the emission frequency of the outgoing laser is, the smaller the vertical angular resolution of the LiDAR is. The higher the vertical scanning frequency of the galvanometer is, the larger the vertical angular resolution of the LiDAR is. On the contrary, the lower the vertical scanning frequency of the galvanometer is, the smaller the vertical angular resolution of the LiDAR is. For magnitude of the vertical angular resolution in the point cloud image, density of the point cloud in the vertical direction is positively correlated with the vertical angular resolution.

In the horizontal direction, the higher the emission frequency of the outgoing laser emitted by the transceiving module 11 is, the larger the horizontal angular resolution of the LiDAR is. On the contrary, the lower the emission frequency of the outgoing laser is, the smaller the vertical angular resolution of the LiDAR is. The greater the angular velocity of the motor is, the smaller the horizontal angular resolution of the LiDAR is. On the contrary, the smaller the angular velocity of the motor 14 is, the greater the horizontal resolution of the LiDAR is.

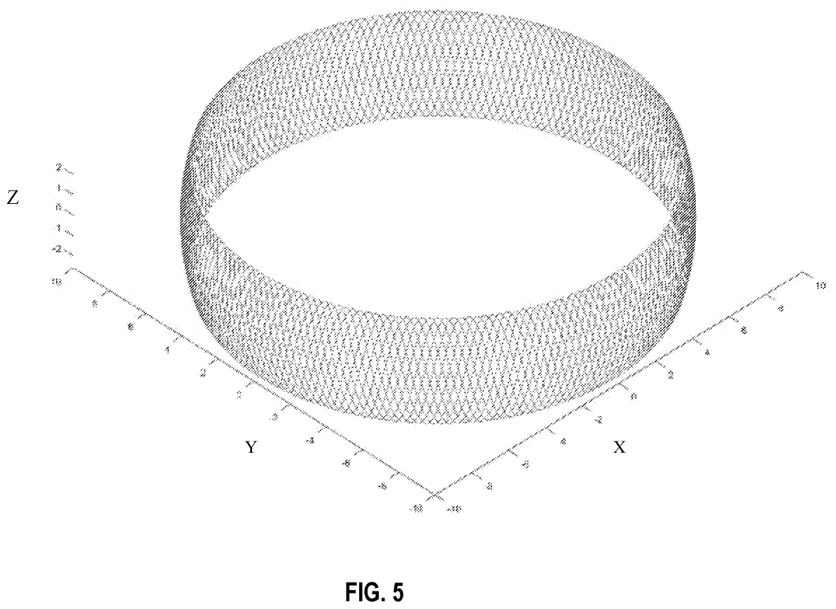

Referring to FIG. 5, the point cloud image is a point cloud image generated when the galvanometer performs vertical scanning in the sine wave scanning mode at scanning time of 2 s with a vertical scanning frequency being 200 Hz, a horizontal rotation frequency of the motor being 11 Hz, and a scanning radius R being 10 meters.

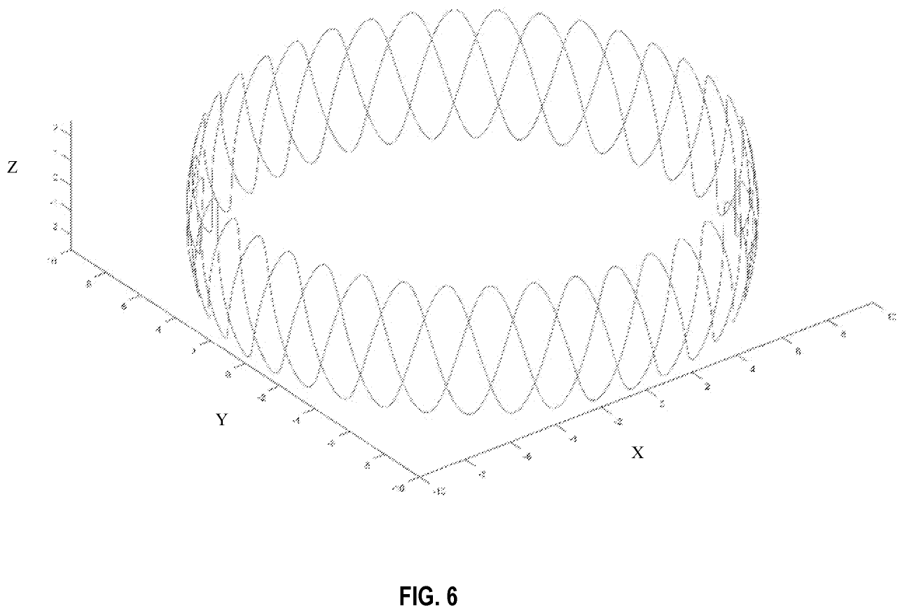

Referring to FIG. 6, the point cloud image is a point cloud image generated when the galvanometer performs vertical scanning in the sine wave scanning mode at a scanning time of 2 s with a vertical scanning frequency being 200 Hz, a horizontal rotation frequency of the motor being 15 Hz, and a scanning radius R being 10 meters.

Because the horizontal rotation frequency of the motor in FIG. 6 is 15 Hz, the horizontal rotation frequency of the motor in FIG. 5 is 11 Hz. An angular velocity of the motor in FIG. 6 is greater than an angular velocity of the motor in FIG. 5. Therefore, the angular resolution of the point cloud image in FIG. 6 is lower than the angular resolution of the point cloud image in FIG. 5.

In a possible embodiment, the transceiving module uses an off-axis solution or a coaxial solution. In the coaxial solution, an outgoing optical path and a reflected optical path of the transceiving module are coaxial. In the off-axis solution, an outgoing optical path and a reflected optical path of the transceiving module are non-coaxial.

For example, in the coaxial solution, the transceiving module 11 includes. an emitter, an emitting optical unit, a beam splitting unit, a receiver, and a receiving optical unit. The emitter is configured to emit the outgoing laser based on the control signal. The emitting optical unit is configured to collimate the outgoing laser from the emitter. The beam splitting unit is configured to transmit the collimated outgoing laser, to receive the echo laser which is deflected by the galvanometer and to deflect the echo laser to the receiving optical unit. The receiving optical unit is configured to focus, on the receiver, the echo laser deflected by the beam splitting unit. The receiver is configured to receive the echo laser after being focused.

In the coaxial solution in this embodiment, stray light that is not transmitted along an optical path direction of the transceiving module cannot enter the transceiving module. Therefore, the transceiving module receives less stray light from background, and a signal-to-noise ratio of the echo laser is high.

The emitter may be an LED (light emitting diode), an LD (laser diode), a VCSEL (vertical cavity surface emitting laser), or the like, or may be an emitter composed of one or more arrays of the foregoing functional devices. The receiver can be APD (Avalanche Photodiode), PIN (Positive-Intrinsic-Negative), APD in Geiger mode, a single-photon receiver, and SiPM (silicon photomultiplier), avalanche photodiode APD and MPPCs (Multi Pixel Photon Counters), or can be a receiver composed of one or more arrays of the foregoing functional devices.

The transceiving module 11 may further include a light filter, where the light filter is arranged between the receiving optical unit and the receiver, and is used to filter out interference light. The interference light may be light outside a wavelength band used for the emitter in this embodiment of the present application, to reduce noise and improve the signal-to-noise ratio.

The emitting optical unit may be a lens or a lens group at the emitter end that is composed of a plurality of lenses, and the lens group at the emitter end may include a fast-axis collimating lens group and a slow-axis collimating lens group, configured to collimate the outgoing laser in the fast-axis direction and the slow-axis direction respectively.

The beam splitting unit can be a reflector with a central circular aperture. After being collimated by the emitting optical unit, the outgoing laser emitted by the emitter passes through the central circular aperture of the reflector with the central circular aperture. After a direction of the outgoing laser is changed by the galvanometer 13, the outgoing laser is used to detect a to-be-detected object. In addition, the galvanometer 13 receives the echo laser and transmits the echo laser to the beam splitting unit in the transceiving module, namely, the reflector with the central circular aperture. The echo laser is reflected by a reflector mirror around the central circular aperture and then is transmitted to the receiving optical unit. Optionally, the beam splitting unit may also be a polarization beam splitting prism, a polarization beam splitting plate, a combined beam splitting prism (a polarization beam splitting plate mounted at the central circular aperture of the reflector with the central circular aperture), or the like.

The receiving optical unit may be a lens or a lens group at the receiver end that is composed of a plurality of lenses, and the lens group at the receiver end may include a positive lens group and a negative lens group. The receiving optical unit may form a telephoto structure.

In the embodiments of the present application, the galvanometer only needs to scan in the vertical direction, namely, the galvanometer is a one-dimensional galvanometer. Compared with a two-dimensional galvanometer, the one-dimensional galvanometer has a larger scanning angle and a larger size of the galvanometer, thereby improving a scanning range of the LiDAR. In addition, the galvanometer can perform 360° horizontal scanning through the rotation of the motor. Compared with a limited horizontal scanning angle of the two-dimensional galvanometer, a horizontal scanning angle of the galvanometer is larger. Thus, scanning angles of the LiDAR can be increased in the vertical direction and the horizontal direction, so that the scanning range of the LiDAR can be increased, a structure of the LiDAR can be simplified, and resolution and precision of the LiDAR can be increased.

In a possible embodiment, angular resolution of the LiDAR along the horizontal direction in a scanning process is non-uniform. Taking LiDAR mounted on the top of a vehicle as an example, because the priority of traffic in front of the vehicle is higher than that of the traffic behind the vehicle, detection resolution in front of the vehicle can be set to be significantly higher than detection resolution behind the vehicle. For example, the LiDAR performs scanning with high resolution in an angular range from 0° to ±60° in front of the vehicle and performs scanning with low resolution in a remaining angular range.

The motor control unit also includes an encoder (namely, an encoding disk). A horizontal rotation angle is obtained through the encoder. When the horizontal rotation angle is within a preset horizontal angle range, an angular velocity of the motor during rotation is increased, thereby improving the resolution. Otherwise, when the horizontal rotation angle is not within the preset horizontal angle range, the angular velocity of the motor during rotation is reduced or maintained in a common state, and resolution is relatively low. In addition, increasing the outgoing frequency, increasing outgoing power, reducing the scanning angle, and increasing the scanning frequency can further increase a detection distance within the preset horizontal angle range, which can also be triggered through the angle recorded in the encoding disk. Details are not described herein. The angular resolution of the LiDAR along the horizontal direction in the scanning process can be adjusted based on an actual application scenario. This can not only make the LiDAR smarter, but also reduce energy consumption and redundancy of an overall system of the LiDAR.

An embodiment of the present application provides a LiDAR scanning method, corresponding to the foregoing LiDAR and applied to the foregoing LiDAR, where the LiDAR includes a transceiving module, a control unit, a galvanometer, and a motor, and the method includes:
emitting, by the transceiving module, an outgoing laser, and receiving an echo laser;
receiving, by the galvanometer, the outgoing laser emitted by the transceiving module, deflecting the outgoing laser outward to scan in a first direction, receiving the echo laser, and deflecting the received echo laser toward the transceiving module;
driving, by the motor, the galvanometer to rotate, so that the outgoing laser can scan in a second direction after being deflected by the galvanometer; and
sending, by the control unit, a control signal to control the transceiving module, the galvanometer, and the motor.

In a possible embodiment, sending, by the control unit, a control signal to control the transceiving module, the galvanometer, and the motor includes:
sending a first control signal to the transceiving module, where the first control signal is used to control the transceiving module to emit the outgoing laser and receive the echo laser;
sending a second control signal to the galvanometer, where the second control signal is used to control the galvanometer to scan in the first direction; and
sending a third control signal to the motor, where the third control signal is used to control the motor to drive the galvanometer to rotate in the second direction.

In a possible embodiment, the control unit includes: a transceiving control unit, a galvanometer control unit, and a motor control unit; and the method further includes:
controlling, by the transceiving control unit, an emission frequency and/or laser intensity of the outgoing laser emitted by the transceiving module;
controlling, by the galvanometer control unit, a scanning angle and a scanning frequency of the galvanometer in the first direction; and
controlling, by the motor control unit, an angular velocity and angular acceleration of the motor in the second direction.

In a possible embodiment, the motor control unit further includes an encoder, where the encoder is configured to obtain a rotation angle of the motor in the second direction.

In a possible embodiment, the first control signal is a square wave signal, a frequency of the square wave signal is related to an emission frequency of the outgoing laser, and magnitude of a level of the square wave signal is related to laser intensity of the outgoing laser.

In a possible embodiment, a vertical scanning mode indicated by the second control signal includes sine wave scanning or triangular wave scanning. The angular acceleration indicated by the third control signal is zero.

In a possible embodiment, the LiDAR further includes a signal processing unit; and the method further includes:
sending, by the control unit, a fourth control signal to the transceiving module, where the fourth control signal is used to control the transceiving module to receive the echo laser; and
generating, by the signal processing unit, a point cloud image based on the echo laser.

In a possible embodiment, the signal processing unit determines a point cloud position based on the scanning angle of the galvanometer in the first direction and the rotation angle of the motor in the second direction, and generates a point cloud image based on the point cloud position.

In a possible embodiment, the transceiving module includes: an emitter, an emitting optical unit, a beam splitting unit, a receiver, and a receiving optical unit; where the method further includes:
emitting, by the emitter, the outgoing laser based on the control signal;
collimating, by the emitting optical unit, the outgoing laser emitted by the emitter;
transmitting, by the beam splitting unit, the collimated outgoing laser, receiving the echo laser which is deflected by the galvanometer, and deflecting the echo laser to the receiving optical unit;
focusing the echo laser deflected by the beam splitting unit, by the receiving optical unit, on the receiver,; and
receiving, by the receiver, the echo laser after being focused.

Based on the LiDAR and the LiDAR scanning method disclosed in the embodiments of the present application, the galvanometer only needs to scan in the vertical direction, namely, the galvanometer is a one-dimensional galvanometer. Compared with a two-dimensional galvanometer, the one-dimensional galvanometer has a larger scanning angle and a larger size of the galvanometer, thereby improving a scanning range of the LiDAR. In addition, the galvanometer can perform 360° horizontal scanning through the rotation of the motor. Compared with a limited horizontal scanning angle of the two-dimensional galvanometer, and a horizontal scanning angle of the galvanometer is larger. In conclusion, the scanning angles of the LiDAR can be increased in the vertical direction and the horizontal direction, so that the structure of the LiDAR can be simplified, the scanning range of the LiDAR can be increased, and the resolution and precision of the LiDAR can be increased.

A person skilled in the art can clearly understand that technologies in the embodiments of the present application can be implemented through software and necessary general-purpose hardware. The general-purpose hardware includes a general-purpose integrated circuit, a general-purpose CPU, a general-purpose memory, a general-purpose element, or the like. Certainly, the technology can alternatively be implemented through dedicated hardware including an application specific integrated circuit, a dedicated CPU, a dedicated memory, a dedicated element, or the like. However, in many cases, the general-purpose hardware is better. Based on such understanding, essence or parts of the technical solutions in the embodiments of the present application that contribute to the related art may be embodied in the form of a software product. The computer software product may be stored in a storage medium, such as a read-only memory (ROM), a random access memory (RAM), a magnetic disk, or an optical disk, and includes several instructions to enable a computer device (a personal computer, a server, a network device, or the like) to perform the methods described in various embodiments or some parts of the embodiments of the present application.

The various embodiments in this specification are described in a progressive manner. The same or similar parts between the various embodiments can be referred to each other. Each embodiment focuses on the difference from other embodiments. In particular, as for a system embodiment, since the system embodiment is basically similar to a method embodiment, the description is relatively simple. For related parts, please refer to the part of the description of the method embodiment.

The embodiments of the present application described above do not constitute a limitation on the protection scope of the present application. Any modification, equivalent replacement and improvement made within the spirit and principle of the present application shall be included within the protection scope of the present application.

What is claimed is:

1. A LiDAR, comprising:
a transceiving module, a galvanometer, a motor, and a control unit,
wherein the transceiving module is configured to emit an outgoing laser and receive an echo laser;
wherein the galvanometer is configured to receive the outgoing laser emitted by the transceiving module, and to deflect the outgoing laser outward to scan in a first direction;
wherein the galvanometer is further configured to receive the echo laser, and to deflect the received echo laser toward the transceiving module;
wherein the motor is configured to drive the galvanometer to rotate, so that the outgoing laser can scan in a second direction after being deflected by the galvanometer; and
wherein the control unit is configured to send a control signal to control the transceiving module, the galvanometer, and the motor.

2. The LiDAR according to claim 1, wherein the control unit is configured to send a first control signal to the transceiving module, to send a second control signal to the galvanometer, and to send a third control signal to the motor,
wherein the first control signal is used to control the transceiving module to emit the outgoing laser and receive the echo laser,
wherein the second control signal is used to control the galvanometer to scan in the first direction, and
wherein the third control signal is used to control the motor to drive the galvanometer to rotate in the second direction.

3. The LiDAR according to claim 2, wherein the control unit comprises:
a transceiving control unit, a galvanometer control unit, and a motor control unit,
wherein the transceiving control unit is configured to control an emission frequency and/or laser intensity of the outgoing laser emitted by the transceiving module,
wherein the galvanometer control unit is configured to control a scanning angle and a scanning frequency of the galvanometer in the first direction, and
wherein the motor control unit is configured to control an angular velocity and angular acceleration of the motor in the second direction.

4. The LiDAR according to claim 3, wherein the motor control unit further comprises an encoder configured to obtain a rotation angle of the motor in the second direction.

5. The LiDAR according to claim 2, wherein the first control signal is a square wave signal,
wherein a frequency of the square wave signal is related to an emission frequency of the outgoing laser, and
wherein magnitude of a level of the square wave signal is related to laser intensity of the outgoing laser.

6. The LiDAR according to claim 2, wherein a vertical scanning mode indicated by the second control signal comprises sine wave scanning or triangular wave scanning, and
wherein angular acceleration indicated by the third control signal is zero.

7. The LiDAR according to claim 1, further comprising a signal processing unit, wherein the signal processing unit is configured to generate a point cloud image based on the echo laser.

8. The LiDAR according to claim 7, wherein the signal processing unit determines a point cloud position based on a scanning angle of the galvanometer in the first direction and a rotation angle of the motor in the second direction, and generates a point cloud image based on the point cloud position.

9. The LiDAR according to claim 1, wherein the control unit is further configured to send a fourth control signal to the transceiving module, and
wherein the fourth control signal is used to control the transceiving module to receive the echo laser.

10. The LiDAR according to claim 1, wherein the transceiving module comprises an emitter, an emitting optical unit, a beam splitting unit, a receiver, and a receiving optical unit,
wherein the emitter is configured to emit the outgoing laser based on the control signal,
wherein the emitting optical unit is configured to collimate the outgoing laser emitted by the emitter,
wherein the beam splitting unit is configured to transmit the collimated outgoing laser, to receive the echo laser deflected by the galvanometer, and to deflect the echo laser to the receiving optical unit,
wherein the receiving optical unit is configured to focus the echo laser deflected by the beam splitting unit on the receiver, and
wherein the receiver is configured to receive the focused echo laser.

11. A LiDAR scanning method, applied to the LiDAR, wherein the LiDAR comprises a transceiving module, a control unit, a galvanometer, and a motor, and the scanning method comprises:
emitting, by the transceiving module, an outgoing laser, and receiving an echo laser;
receiving, by the galvanometer, the outgoing laser emitted by the transceiving module, deflecting the outgoing laser outward to scan in a first direction, receiving the echo laser, and deflecting the received echo laser toward the transceiving module;
driving, by the motor, the galvanometer to rotate, so that the outgoing laser can scan in a second direction after being deflected by the galvanometer; and
sending, by the control unit, a control signal to control the transceiving module, the galvanometer, and the motor.
